(19) United States
(12) Patent Application Publication
(10) Pub. No.: US 2013/0119733 A1
(43) Pub. Date: May 16, 2013

(54) Method and apparatus for ingress and egress of chair

(71) Applicant: WILLIAM L. WHITE, Phoenix, AZ (US)

(72) Inventor: WILLIAM L. WHITE, Phoenix, AZ (US)

(21) Appl. No.: 13/694,769

(22) Filed: Jan. 3, 2013

Related U.S. Application Data
(63) Continuation-in-part of application No. 12/932,536, filed on Feb. 28, 2011.
Application No. 12/932,536 is a continuation-in-part of application No. 12/156,469, filed on May 30, 2008, now Pat. No. 7,896,442.

(51) Int. Cl. A61G 5/14

(52) U.S. Cl. CPC A61G 5/14
USPC 297/284.1; 297/311

(57) ABSTRACT

An upholstered armchair conceals stirrup assemblies in the armrests of the chair for manual deployment to position foot stirrups extending inwardly and above the armrests.

This is a continuation-in-part of application Ser. No. 12/932,536, filed Feb. 28, 2011, which is a continuation-in-part of application Ser. No. 12/156,469, filed May 30, 2008, now U.S. Pat. No. 7,896,442.

This invention pertains to chairs.

More particularly, the invention pertains to a chair that facilitates stretching inner leg muscles.

It would be desirable to provide an improved method and apparatus to stretch the inner leg muscles.

Therefore, it is a principal object of the instant invention to provide an improved system for an individual to stress inner leg muscles.

This and other, further and more specific objects and advantages of the invention will be apparent from the following detailed description thereof, taken in conjunction with the drawings, in which:

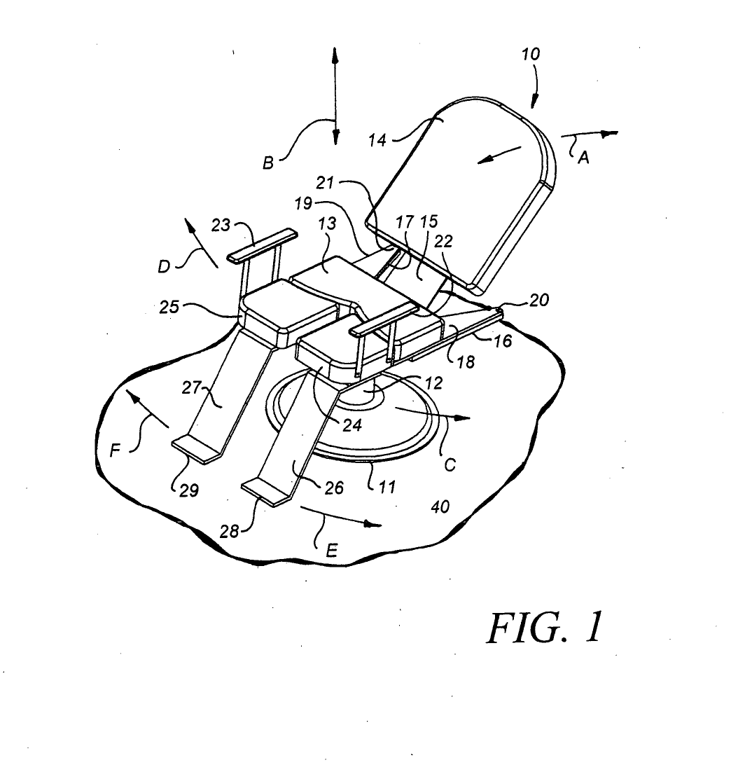

FIG. 1 is a perspective view illustrating a chair constructed in accordance with the invention;

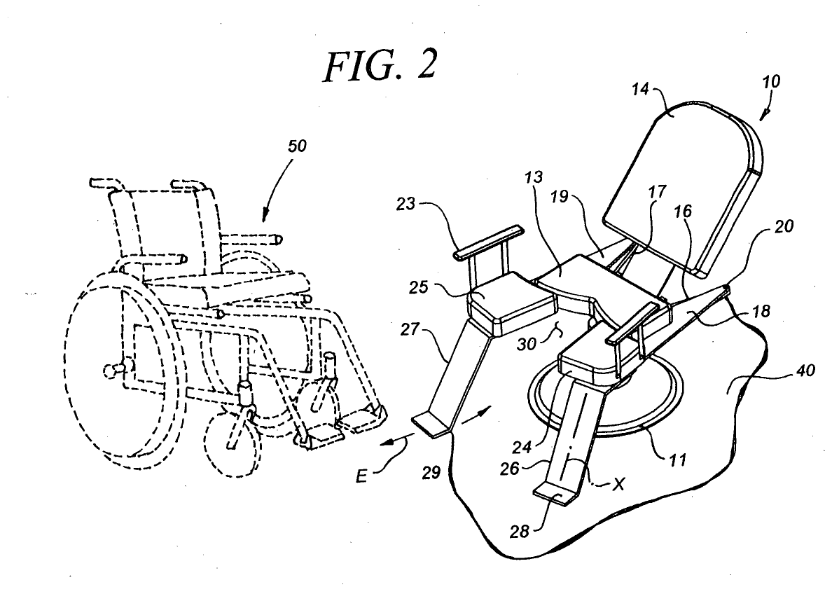

FIG. 2 is a perspective view of the chair of FIG. 1 illustrating the mode of operation thereof;

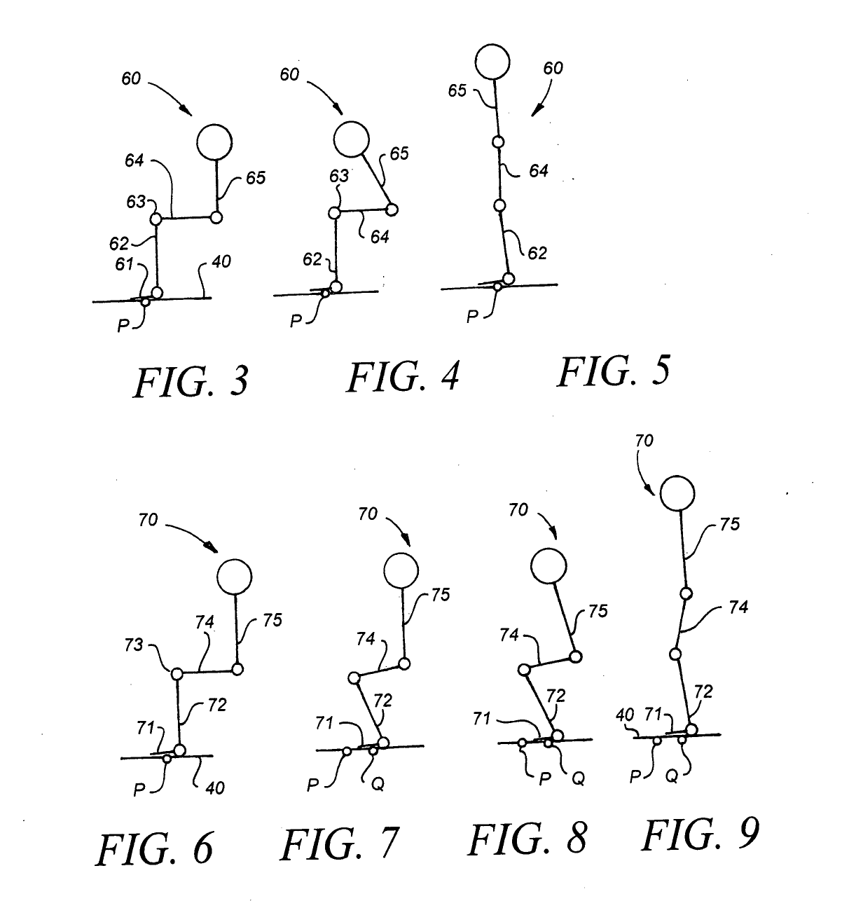

FIG. 3 is a side elevation view illustrating an individual's orientation when sitting in a conventional chair;

FIG. 4 is a side elevation view illustrating an individual leaning forward to begin arising from a conventional chair;

FIG. 5 is a side elevation view illustrating an individual standing after the individual has arisen from a convention chair;

FIG. 6 is side elevation view illustrating an individual's orientation when sitting in a chair constructed in accordance with one embodiment of the invention;

FIG. 7 is a side elevation view illustrating an individual beginning to arise from a chair in accordance with a method in one embodiment of the invention;

FIG. 8 is a side elevation view illustrating an individual beginning to arise from a chair in accordance with the method fo the invention of FIG. 7;

FIG. 9 is a side elevation view illustrating an individual arisen from the chair in accordance with the method of the invention of FIG. 7;

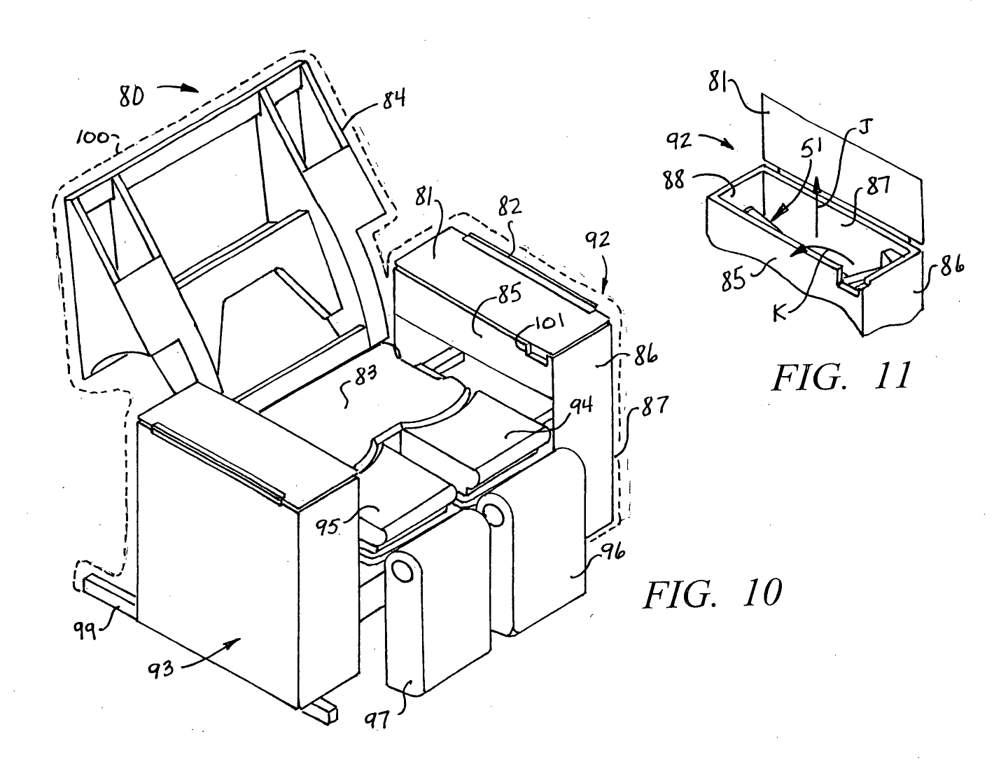

FIG. 10 is a perspective view illustrating a chair constructed in accordance with an alternate embodiment of the invention;

FIG. 11 is a perspective view of a portion of an arm rest of the chair of FIG. 10 illustrating the mode of operation thereof;

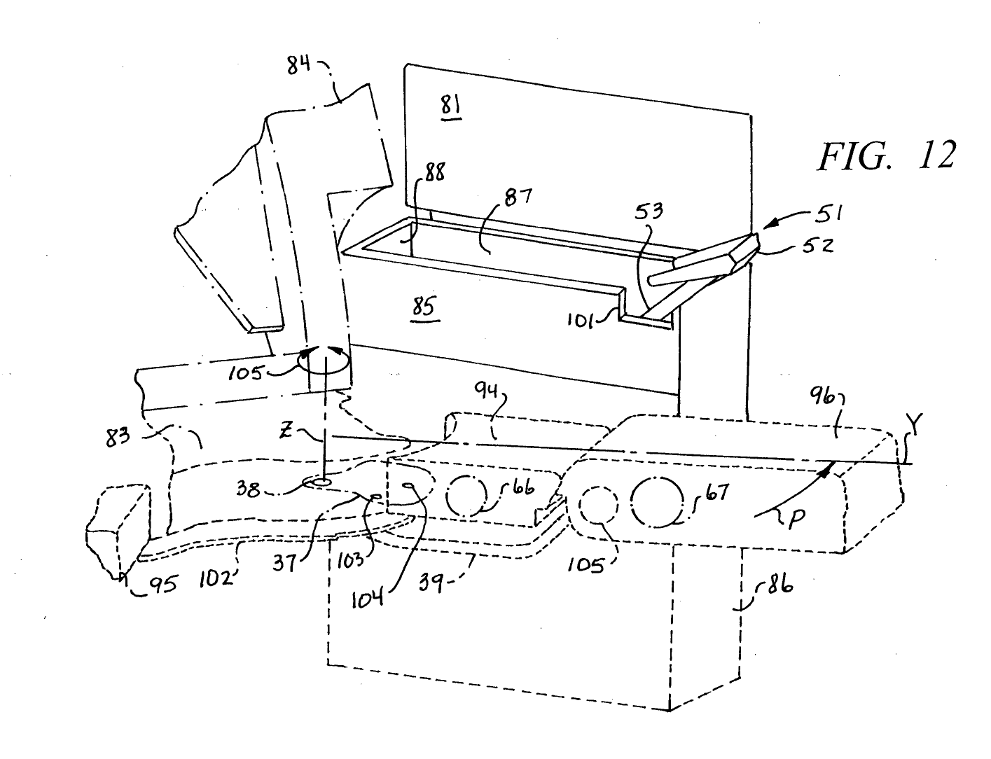

FIG. 12 is a perspective view of a portion of the chair of FIG. 10 further illustrating the mode of operation thereof;

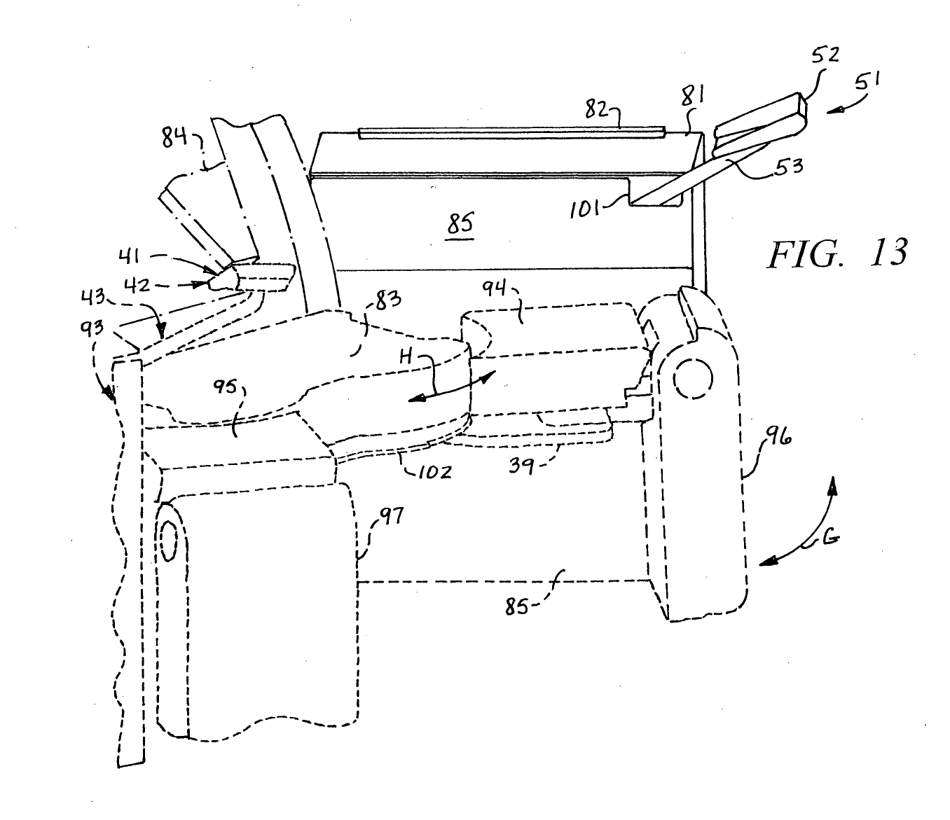

FIG. 13 is a perspective view of a portion of the chair of FIG. 10 also further illustrating the mode of operation thereof;

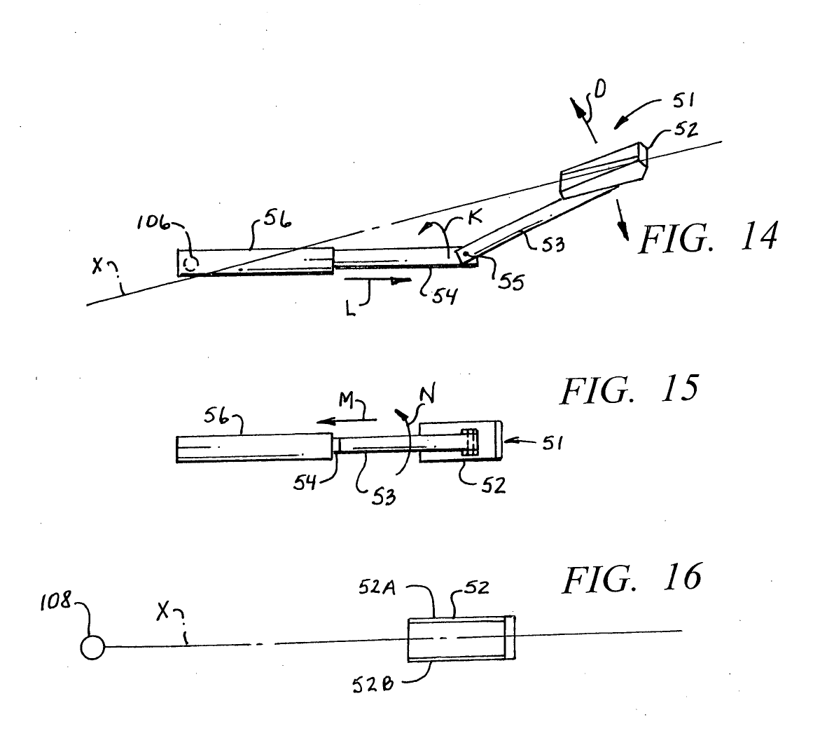

FIG. 14 is a perspective view illustrating a stirrup assembly constructed in accordance with the invention;

FIG. 15 is a bottom view of the stirrup assembly of FIG. 14 illustrating the mode of operation thereof;

FIG. 16 is a diagram illustrating the preferred alignment of a stirrup with a hip socket or joint of an individual seated in the chair of FIG. 10;

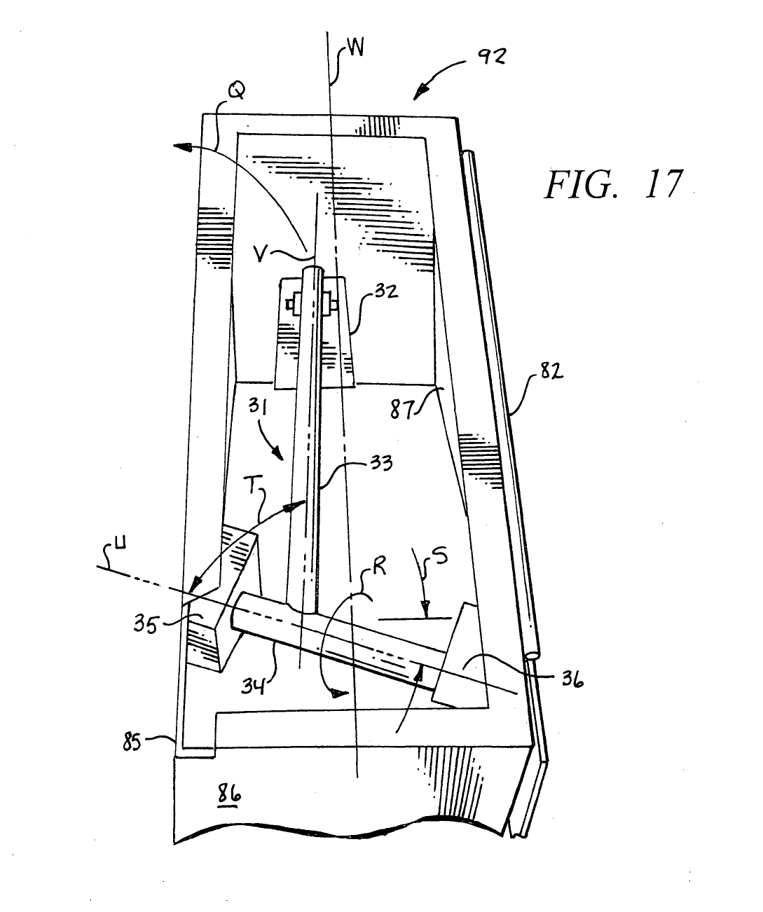

FIG. 17 is a perspective view illustrating an alternate stirrup assembly constructed in accordance with the invention;

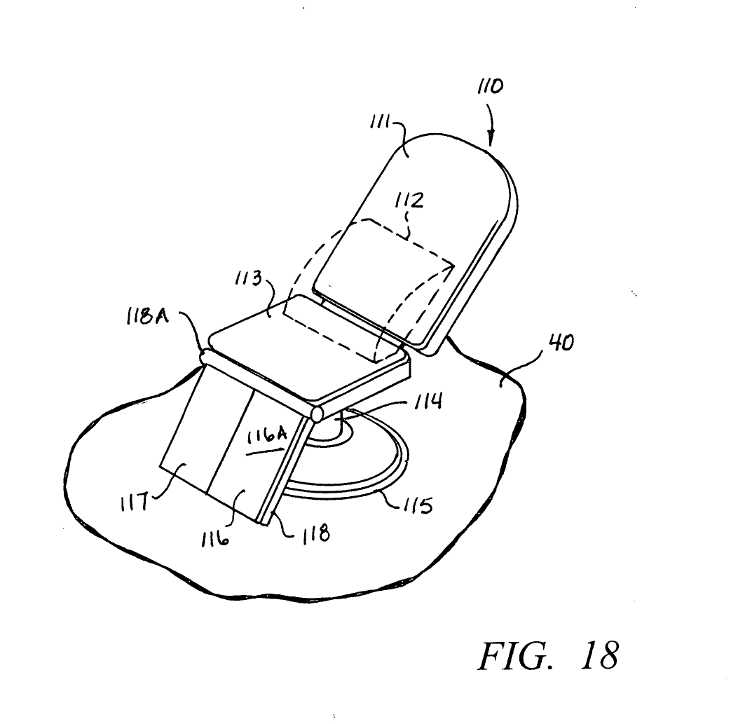

FIG. 18 is a perspective view illustrating a chair constructed in accordance with a further embodiment of the invention;

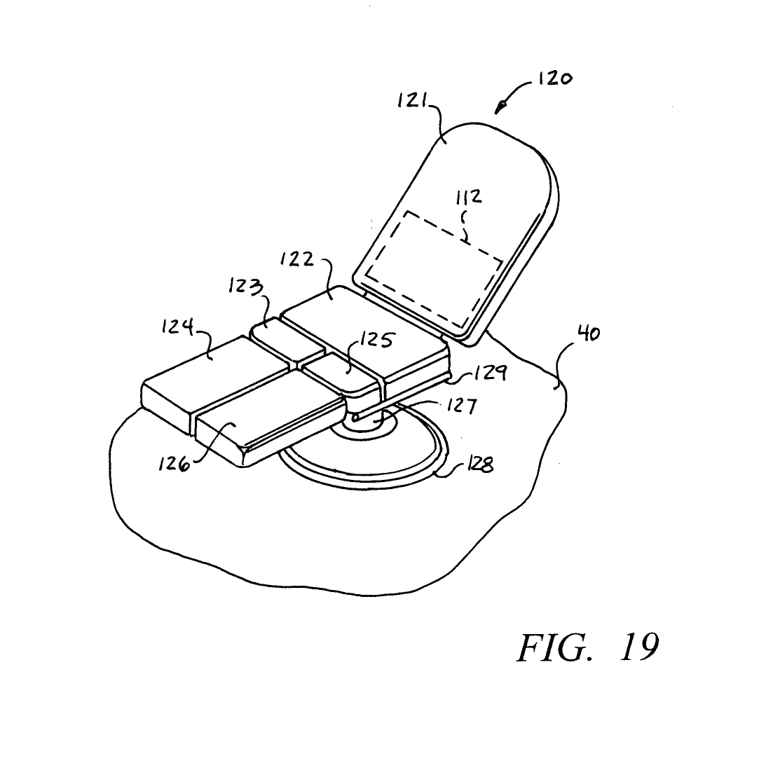

FIG. 19 is a perspective view illustrating a chair constructed in accordance with another embodiment of the invention;

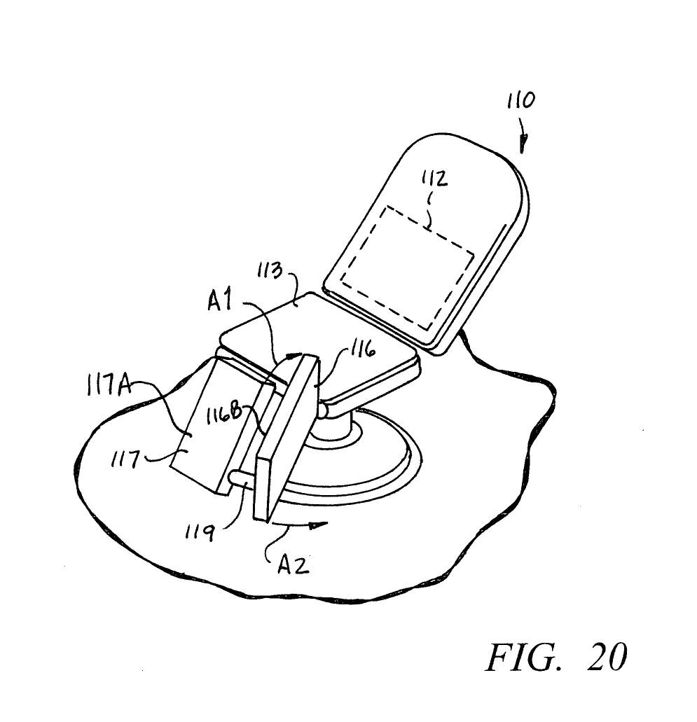

FIG. 20 is a perspective view illustrating further construction details of the chair of FIG. 18 and the mode of operation thereof;

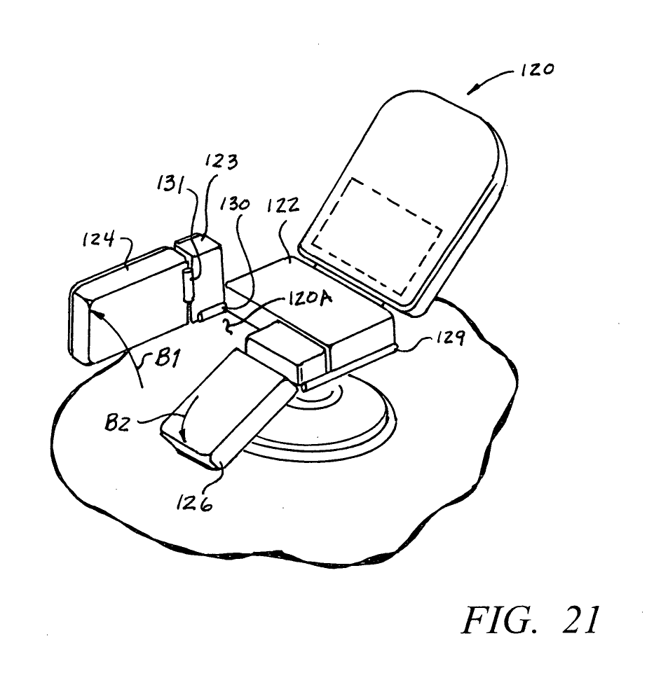

FIG. 21 is a perspective view illustrating further construction details of the chair of FIG. 19 and the mode of operation thereof;

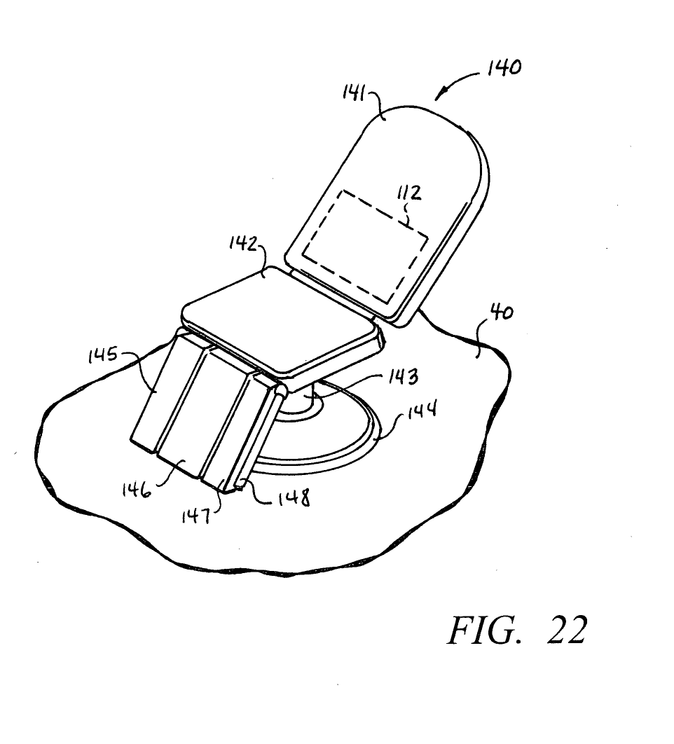

FIG. 22 is a perspective view illustrating a chair constructed in accordance with still a further embodiment of the invention;

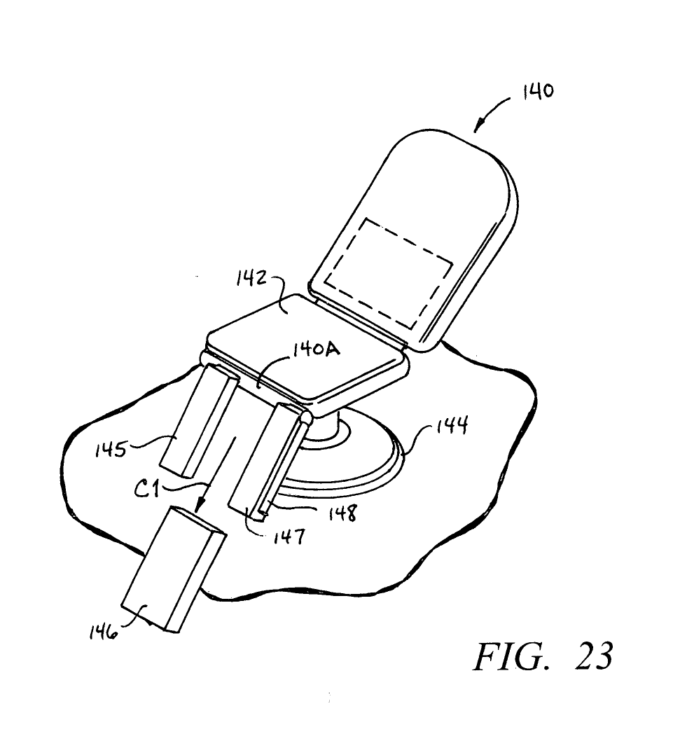

FIG. 23 is a perspective view illustrating the mode of operation of the chair of FIG. 22;

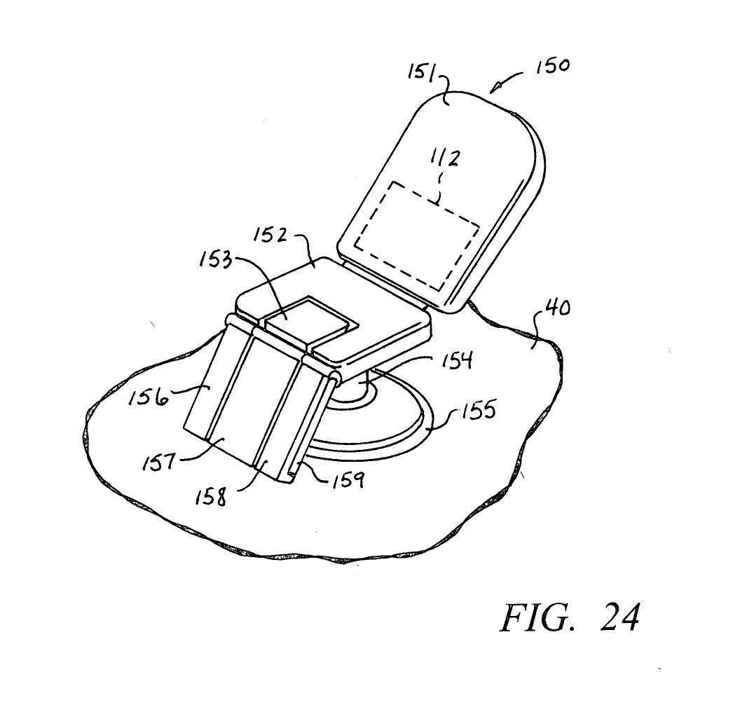

FIG. 24 is a perspective view illustrating a chair constructed in accordance with still another embodiment of the invention;

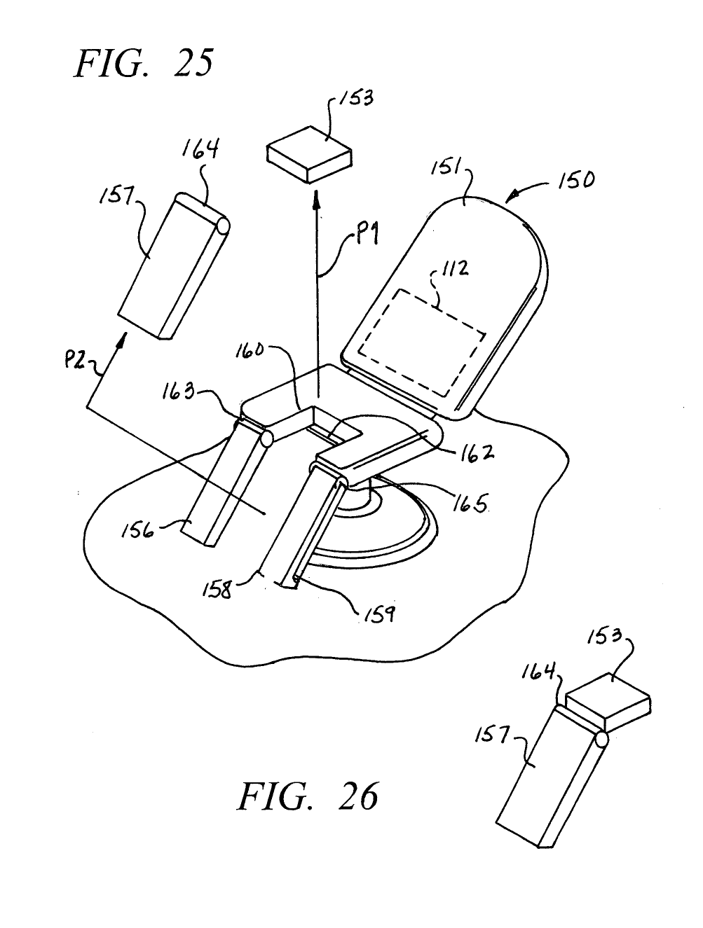

FIG. 25 is an exploded perspective view illustrating further construction details of the chair of FIG. 25 and the mode of operation thereof;

FIG. 26 is a perspective view illustrating an alternate construction of a portion of the chair of FIG. 25;

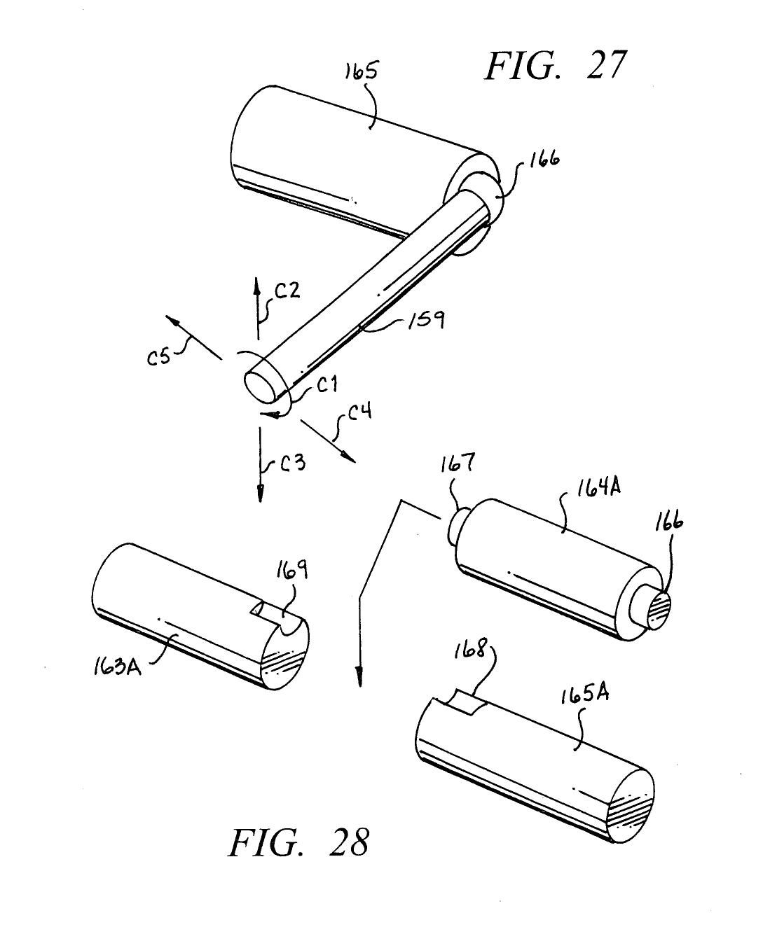

FIG. 27 is a perspective view illustrating a construction utilized in the front leg support portions of a chair constructed in accordance with the invention in order to permit rotation of a calf rest about multiple axes; and,

FIG. 28 is a perspective view illustrating a possible construction utilized in the chair of FIGS. 24 and 25.

Briefly, in accordance with the invention, I provide an improved method to facilitate moving from a seated position to an upright position to travel to another piece of furniture to sit or lie, and minimize the stress on the back and legs. The method includes the step of providing a chair on a floor. The chair includes a seat at a first elevation above the floor and having a fixed rear portion, and a front portion. The front portion includes a first section, and a second section adjacent to and laterally separable from the first section. A first foot rest is attached to and spaced downwardly from the first section and forwardly from the rear portion. A second foot rest is attached to and spaced downwardly from the second section and forwardly from the rear portion. The method of the invention also includes the steps of sitting in the chair with one foot on the first foot rest, the other foot on the second foot rest, and each knee pronated; sitting on the fixed rear portion of the seat; separating one leg from the other and stretching inner leg muscles by separating laterally the first section from the second section, and separating the first foot rest from the second foot rest; increasing the pronation of at least one knee, stretching at least one thigh muscle, and aligning the one foot beneath the buttocks by moving the one foot from the first foot rest to the floor, and along the floor rearwardly toward the rear portion of the seat; reducing the pronation of the knees by rising from the chair to a standing position; and, moving to the other piece of furniture. The seat can, prior to leaving the chair, be raised to a second elevation above the floor greater than the first elevation.

In another embodiment of the invention, I provide a chair to position the feet of an individual above his buttocks when seated in the chair. The chair comprises a seat at a first elevation above the floor; a first upper leg support section pivotally attached to the seat for movement in a generally horizontally oriented plane; a second upper leg support section adjacent to and laterally separable from the first section and pivotally attached to the seat for movement in a generally horizontally oriented plane; a first lower leg support section pivotally attached to the first upper leg support section for movement between a generally horizontal orientation and a generally vertical orientation; a second lower leg support section pivotally attached to the second upper leg support section for movement between a generally horizontal orientation and a generally vertical orientation and laterally separable from the first lower leg support section; a first hollow arm rest; a second hollow arm rest; a first stirrup assembly mounted in the first hollow arm rest and moveable between at least two operative positions, a first operative position stowed in the first arm rest, and a second operative position deployed from the first arm rest to extend in part inwardly and outwardly from the first arm rest toward the second arm rest; and, a second stirrup assembly mounted in the second hollow arm rest and moveable between at least two operative positions, a first operative position stowed in the second arm rest, and a second operative position deployed from the second arm rest to extend in part inwardly and outwardly from the second arm rest toward the first arm rest.

In a further embodiment of the invention, provided is an improved chair to facilitate moving from a seated position to an upright position to travel to another piece of furniture to sit or lie, and minimize the stress on the back and legs. The chair comprises a seat. The seat is at a first elevation above a floor and has a rear portion in a generally horizontal orientation, and a front portion. The front portion includes a front seat portion including at least a first section (123, 125, 153) movable between at least two operative positions, a first generally horizontal orientation occupying a space forwardly from the rear portion, and a second generally vertical orientation in which the first section vacates at least a portion of the space. The chair also comprises a front leg support portion. The front leg portion includes a first calf rest (116, 126, 147, 158) attached to and spaced downwardly from the front seat portion and forwardly from the rear portion. The first calf rest has an upper and a lower surface. The front leg portion also includes a second calf rest (117, 124, 145, 156) attached to and spaced downwardly from the front seat portion and forwardly from the rear portion. The second calf rest has a top and a bottom surface. The first and second calf rests are each pivotally movable between a primary upwardly facing orientation and a secondary laterally facing orientation. Each of the first and section foot rests move away from the other when moving from the primary orientation to the secondary orientation.

In another embodiment of the invention, provided is an improved chair to facilitate moving from a seated position to an upright position to travel to another piece of furniture to sit or lie, and to minimize the stress on the back and legs. The chair comprises a seat at a first elevation above a floor. The seat has a rear seat portion in a generally horizontal orientation, and a front portion. The front portion includes a first section, and a second section adjacent the first section. The first and second sections are each movable between at least two operative positions, a first generally horizontal orientation occupying a space forwardly from the rear portion, and a second generally vertical orientation in which the first and second sections each vacate at least a portion of the space. The chair also includes a front leg support portion. The front leg support portion includes a first calf rest attached to and spaced downwardly from the front seat portion and forwardly from the rear portion. The first calf rest has an upper and a lower surface. The front leg support portion also includes a second calf rest attached to and spaced downwardly from the front seat portion and forwardly from the rear portion. The second calf rest has a top and a bottom surface. The first and second calf rests are each pivotally movable between at least two operative positions, a primary upwardly facing orientation and a secondary laterally facing orientation. Each of the first and section calf rests move away from the other when moving from the primary orientation to the secondary orientation.

In still another embodiment of the invention, provided is an improved chair to facilitate moving from a seated position to an upright position to travel to another piece of furniture to sit or lie, and to minimize the stress on the back and legs. The chair comprises a seat at a first elevation above a floor. The seat has a rear seat portion in a generally horizontal orientation. The seat also has a front seat portion including a first section, and a second section adjacent the first section. The first and second sections are each movable between a first generally horizontal orientation occupying a space forwardly from the rear portion, and a second generally vertical orientation in which the first and second sections each vacate at least a portion of the space. The chair also includes a front leg support portion including a first calf rest attached to and spaced downwardly from the front seat portion and forwardly from the rear portion. The first calf rest has an upper and a lower surface. The front leg portion also includes a second calf rest attached to and spaced downwardly from the front seat portion and forwardly from the rear portion. The second calf rest has a top and a bottom surface. The front leg portion also includes a first foot rest (119) extending outwardly from the lower surface of the first calf rest, and a second foot rest extending-outwardly from the bottom surface of the second calf rest. The first and second calf rests are each pivotally movable between at least two operative positions, a primary upwardly facing orientation and a secondary laterally facing orientation. Each of the first and second calf rests move away from the other when moving from the primary orientation to the secondary orientation. The first foot rest extends laterally toward the second calf rest when the first and second calf rests are each in the secondary laterally facing orientation, and the second foot rest extends laterally toward the first calf rest when the first and second calf rests are each in the secondary laterally facing orientation. The chair also includes an inflatable back support (112) contacting the seat.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a chair constructed in accordance with the invention and generally indicated by reference character 10.

Chair 10 includes a base 11 on floor 40. Leg 12 upwardly depends from base 11. Chair 10 can, if desired, include two or more legs. Leg 12 can, if desired, have a pneumatic configuration like that of a barber chair so that leg 12 can be operated to raise and lower in the directions indicated by arrow B the seat portions 12, 24, 25 and other components mounted on the upper end of leg 12.

Lower triangular wings 16 and 17 are fixedly secured to the upper end (not visible) of leg 12. Upper triangular wing 18 is pivotally slidably attached to lower wing 16 by pin 20. Upper triangular wing 19 is pivotally slidably attached to lower win 17 by pin 21. The shape and dimension of wing 16 is equivalent to that of wing 17. The shape and dimension of wing 18 is equivalent to that of wing 19.

The seat of chair 10 includes portions 13, 24, 25.

Rear portion 13 is fixedly secured to the upper end (not visible) of leg 12. Front portion 24 is fixedly secured to upper wing 18. Front portion 25 is fixedly secured to upper wing 19.

Leg rest 26 is fixedly secured to upper wing 18. Foot rest 28 is attached to leg rest 26. Leg rest 27 is fixedly secured to upper wing 19. Foot rest 29 is attached to leg rest 27. Arm rest 22 is attached to front seat portion 24. Arm rest 23 is attached to front seat portion 25. The arm rests 22 and 23, leg rests 26 and 27, and foot rests 28 and 29 can be mounted on any desired structural member(s) of chair 10.

Member 15 secures back rest 14 to the upper end (not visible) of leg 12. Chair 10 can be constructed with any of a variety of known mechanical systems which permit the angle of tilt of back rest 14 to be adjusted in the directions indicated by arrows A. Similarly, chair 10 can be constructed with any desired mechanical system that permits front portions 24 and 25 to be separated in the directions indicated by arrows C and D in FIG. 1, and, to be moved back together to the configuration illustrated in FIG. 1. Such a mechanical system may, or may not, include motors operable to displaced front portions 24 and 25 in the directions indicated by arrows C and D. In the chair 10 illustrated in FIG. 1, front portion 24 is displaceable in the direction of arrow C from the closed position shown in FIG. 1 by simply grasping and manually pulling front portion 24 in the direction of arrow C such that upper wing 18 pivots about pin 20 and slides over lower wing 16 in the direction of arrow C to the open position illustrated in FIG. 2. Likewise, front portion 25 is displaceable in the direction of arrow D from the closed position shown in FIG. 1 by simply grasping and manually pulling front portion 25 in the direction of arrow D such that upper wing 19 pivots about pin 21 and slides over lower wing 17 to the open position illustrated in FIG. 2.

Front portion 25 is displaceable in a direction opposite that of arrow D from the open position shown in FIG. 2 by simply grasping and manually pushing front portion 25 in the direction opposite that of arrow D such that upper wing 19 pivots about pin 21 and slides over lower wing 17 to the closed position illustrated in FIG. 2. Likewise, front portion 24 is displaceable in a direction opposite that of arrow C from the open position shown in FIG. 2 by simply grasping and manually pushing front portion 24 in the direction opposite that of arrow C such that upper wing 18 pivots about pin 20 and slides over lower wing 17 to the closed position illustrated in FIG. 2.

When front portions 24 and 25 are moved between the closed position of FIG. 1 and the open position of FIG. 2, foot rest 28, leg rest 26 and arm rest 22 move simultaneously with front portion 24. In a similar manner, foot rest 29, leg rest 27, and arm rest 23 move simultaneously with front portion 25.

Chair 10 can be constructed such that each leg rest 26 and/or foot rest 28 can be indexed and moved to a plurality of different positions by rotating each leg rest 26 and/or foot rest 28 about a vertically oriented axis X (FIG. 2).

Chair 10 can also be constructed such that each leg rest 27 and/or foot rest 29 can be indexed and moved to a plurality of different positions by moving each leg rest 27 and/or foot rest 29 in the directions indicated by arrows E toward or away from base 11 (FIG. 2).

In FIGS. 1 and 2, front portions 24 and 25 are generally parallel to floor 40. Chain 10 can be constructed such that each portion 24, 25, 12 of the seat is or can be adjustably tilted with respect to floor 40.

The chair 10 was originally constructed to provide a means for an individual, while sitting, to separate his or her legs to stretch gently the muscles in the inner areas of the legs. Such muscles can, if injured, take a significant amount of time to heal.

One particular benefit discovered after the chair of the invention was constructed is that when the chair is used to stretch the inner muscles of the legs, it enables an individual in the chair to relax inner leg muscles because the body of the individual is supported by the chair. The leg muscles are not engaged to support the body.

Another benefit discovered after the chair of the invention was constructed is that when the front portions 24 and 25 are moved from the closed position of FIG. 1 to the open position of FIG. 2, the front portions 24 and 25, footrests 28 and 29, and leg rests 26 and 27 “carry” and laterally displace the feet and legs of an individual sitting in the chair. Consequently, the individual need not exert any energy to separate his or her legs, which enables the individual to concentrate on relaxing so the muscles are able to better stretch.

Still another benefit discovered after the chair of the invention was constructed is that each seat portion 24 and 25 can be incrementally moved from the closed position of FIG. 1 to the open position of FIG. 2, which permits the amount of stretch to be adjusted per individual taste and which permits the distance between front portions 24 and 25 to be gradually increased to increase the amount of stretch as the leg muscles relax in the stretch.

After the chair 10 was developed as a means to stretch the inner muscles of the legs, I discovered a first unexpected and unpredicted benefit of the chair 10. The chair 10 is, when utilized in accordance with one embodiment of the invention, believed to be particularly useful in enabling an individual to sit in and arise from the chair, especially when the individual is older or is convalescing. In attempting “after the fact” to theorize why this is the case, the following analysis has been developed.

When an individual sits in a chair, movement of the individuals legs and body is restricted, and blood tends to pool in the lower extremities of the individual. After time passes, the individual's leg muscles and joints tend to stiffen. While such stiffening may not be the case with young children and young adults, it is more of an issue with advancing age and with patent attorneys, Patent Office Examiners, and other individuals that spend long periods of office time seated or are recuperating from an injury or illness.

Attempting to arise from a chair can, for some individuals, be a rather slow, painful, and awkward experience.

Further, if attempting to arise from a chair is difficult, an individual is, when attempting to leave the chair, more likely to bend far forward to produce momentum to stand up and, accordingly, to put his back at risk and to injure his back.

FIGS. 3 to 5 illustrate a conventional procedure for arising from a chair. In FIG. 3 an individual 60 is seated in a chair (not shown). The individual 60 has an upper body, upper leg (thigh) 64, lower leg (calf) 62, and foot 61. In order to arise from the chair, the individual tilts forward in the manner illustrated in FIG. 4 to gain some momentum, and then uses his legs to move to the standing position of FIG. 5. While literally millions of individuals perform this maneuver daily, age or illness render the maneuver more difficult, particularly because of the strength required by the thighs and “core” and because of the stress the maneuver can place on the lower back if the individual tends to arch his back (instead of maintaining a flat back) when tilting forward in the manner illustrated in FIG. 4. One factor that aggravates this situation is that the individual's feet remain in front of his upper body in a position over point P indicated in FIGS. 3 to 5.

In one embodiment of the invention, an individual in chair 10 arises in the following manner. This procedure is illustrated in FIGS. 6 to 9 with respect to an individual generally indicated by reference character 70 and including foot 71, calf 72, thigh 74, and upper body 75. First, the individual 70 sits on the rear portion 13 of the seat of chair 10 (not shown). Second, front sections 24 and 25 are moved from the closed position of FIG. 1 to the open position of FIG. 2. This functions to stretch and activate inner leg muscles. Third, the individual moves one or both of his or her feet 71 laterally inwardly off foot rests 28 and 29 toward one another to a position generally over a point P, as illustrated in FIG. 6. Fourth, the individual continues to move his foot rearwardly in a direction toward base 11 and rear portion 13 to a position over point Q. The position of foot 71 over point Q is illustrated in FIG. 7. In FIG. 7, foot 71 is generally beneath and aligned with the hips and upper body of individual 70, which produces the result of requiring less energy to arise from chair 10. The other result of moving foot 71 from a position over point P to a position over point Q is that it further pronates the knee and stretches the quadriceps. This is particularly advantageous because leg muscles tend to stiffen when sitting in a chair. Stretching leg muscles before standing helps overcome stiffness and place the legs in better condition to function. Fifth, the individual his or her upper body 75 forward in the manner illustrated in FIG. 8. The upper body tilt in FIG. 8 is significantly less than the upper body tilt in FIG. 4 because of the position of foot 71 over point Q. Sixth, the individual uses his legs to stand in the orientation illustrated in FIG. 9 with his foot 71 over point Q.

While the foregoing theoretical analysis evolved after the invention was developed, the analysis is believed to comprise a reasonably plausible explanation and is, at least in part, readily tested by standing up from a chair in the conventional manner illustrated in FIGS. 3 to 5, and by then standing up from a chair with a seat that permits the movements illustrated in FIGS. 6 to 9.

The “pre-standing” stretching of the leg muscles and positioning of foot 71 over point Q result in significantly less effort being required in the method of FIGS. 6 to 9, which is believed to be of critical importance when moving a convalescing individual from a bed to the chair 10, or moving the convalescing individual out of chair 10 to a bed or other desired location.

When an individual is sitting in the chair and wishes to stand, raising the chair 10 and the elevation of the seat can be beneficial because when the individual steps off foot rests 28 and 29, the foot rests 28 and 29 are above the floor 40. Increasing the height above floor 40 of the footrests 28 and 29 before an individual leaves the chair 10 can, when the individual steps off footrests 28 and 29, function to partially straighten the leg and reduce the distance that the individual must upwardly move his upper body to reach the standing position of FIG. 9.

Similarly, raising the seat of chair 10 can facilitate an individual's initially sitting in chair 10 by reducing the distance that an individual has to lower his upper body such that his buttocks contact the rear portion 13 of the chair 10. After the individual sits on rear potion 13 (with portions 14 and 25 in the open position of FIG. 2), the individual places his feet on foot rests 28 and 29 and front portions are moved from the open position of FIG. 2 to the closed position of FIG. 1.

After the chair 10 was constructed, I discovered a second unanticipated benefit of the chair. The ability of the front portions of the chair to separate permits, in accordance with another embodiment of the invention, ready access to the perineal area of an individual sitting in the chair which facilitates cleaning or otherwise treating the perineal area. In comparison, attempting to clean or otherwise treat the perineal area while an individual is in bed can require that two or more individuals be present to turn the individual over and access the perineal area.

When the chair was developed, I was not aware of any market trend emphasizing that there was a problem stretching the inner muscles of the legs or that the market was searching for another way to stretch the inner muscles of the leg, to facilitate arising from a chair, or to facilitate cleaning or treating the perineal area. There appears to be no market need or trend directing a particular solution in such respects, much less somehow suggesting a chair structure. Even if a chair structure were suggested, there evidently existed at the time of the invention no motivation to divide the seat of a chair into sections, to make some of the sections movable, and some not, and to utilize such a chair in a manner that facilitates stretching, facilitates ingress into and egress from the chair, and facilitates cleaning or otherwise treating the perineal area.

Pronation. As used herein, pronation refers to bending of the knee and occurs when the bottom part of the leg (calf and foot) pivots about the knee so that (1) the foot moves rearwardly and upwardly toward the back of the thing, and (2) the bottom part (calf) and upper part (thigh) of the leg are not in alignment. Pivoting the foot and bottom part of the leg about the knee until the foot touches or is near the buttocks produces a severely pronated knee that is bent back on itself.

An alternate embodiment of the invention is illustrated in FIGS. 10 to 16 and comprises a chair 80 including a back 84, seat 83, upper leg supports 94 and 95, lower leg supports 96 and 97, and armrests 92 and 93 mounted on a ground engaging base structure 99. Back 84 is constructed to be adjusted and tilted in conventional fashion to a variety of support positions, as is the case with back rest 14 in FIG. 1. Back 84 preferably can, in addition to being tilted to a plurality of canted support positions intermediate the horizontal and the vertical, be tilted downwardly away from seat 83 to a generally horizontally oriented support position and can be tilted upwardly to a generally vertically oriented support position. When back 84 is in the horizontally oriented support position back 84 and seat 83 generally lie in a common horizontal plane. When back 84 is in the vertically oriented support position, back 84 is generally normal to seat 83.

The structure of arm rest 93 is generally equivalent to the structure of arm rest 92. Arm rest 92 includes a hollow orthogonal box structure including sides 85, 86, 87, 88 and top 81 pivotally attached to the top of side 87 by piano hinge 82. A deployable stirrup assembly 51 is housed in arm rest 92 and is described in more detail below.

Seat 83 preferably, but not necessarily, remains in fixed position during operation of chair 80. Seat 83 includes fixed, horizontally-oriented, bottom support panel 102: The inner, or upper, end of lower leg support 96 is pivotally attached to support panel 39 (FIG. 12) and, as indicated by arrows G in FIG. 13, can be pivoted by a motor 67 (FIG. 12) between the vertically oriented position illustrated in FIG. 13 and the horizontally oriented position illustrated in FIG. 12. Upper leg support 94 is mounted on horizontally-oriented support panel 102. One end of panel 37 (FIG. 12) is pivotally attached to panel 102 by pin 38 (FIG. 12). The other end of panel 37 is fixedly secured to support panel 39 such that panels 37 and 39 simultaneously pivot in the manner indicated by arrows 105 in FIG. 12 about pin 38 and about the vertical axis of rotation Z extending through pin 38. Panels 37 and 39, upper leg support 94, and lower leg support 96 simultaneously pivot through a horizontally oriented arc between the stowed position of FIG. 10 and the deployed position of FIGS. 12 and 13. When panels 37 and 39 are pivoted between said stowed and deployed positions, lower leg rest 96 can be in the position shown in FIG. 12 or the position shown in FIG. 13 or in any position therebetween. Motor 67 is controlled as desired to pivot lower leg rest 96 about horizontally oriented pin 105 in the manner indicated by arrows G in FIG. 13. Consequently, in addition to having the capacity to being vertically (down position) or horizontally (up position) positioned in the manner illustrated in FIGS. 13 and 12, respectively, lower leg rest 96 can be positioned at any desired cant, or angle, therebetween. Motor 66 is operated as desired to pivot panels 37 and 39 between the stowed position of FIG. 10 and the deployed position of FIGS. 12 and 13, or, if desired panels 37 and 39 can be manually displaced and pivoted between the stowed position of FIG. 10 and the deployed position of Figs. And 13.

When panel 37 is in the stowed position, a first locking pin (not shown) is activated to move into and extend through aperture 103 to secure panel 37 in position. The pin is withdrawn from aperture 103 prior to moving panel 37 to the deployed position. When panel 37 is in the deployed position, a second locking pin (not shown) is activated to move into and extend through aperture 104 to secure panel 37 in the deployed position. The pin is withdrawn from aperture 104 prior to moving panel 37 back to the stowed position.

Upper leg support 95 and lower leg support 97 are provide with support panels and motors comparable to panels 37 and 39 and motors 66 and 67 such that supports 95 and 97 are operated in a fashion comparable to supports 94 and 96 except, of course, when supports 95 and 97 pivot from the stowed position of FIG. 10 to the deployed position of FIG. 13, supports 95 and 97 pivot in a direction away from supports 94 and 96.

Chair 80 is preferably constructed such that when an individual is seated on seat 83, his left hip ball-and-socket joint is positioned within three inches of axis Z (which axis passes through the center of pin 38), is preferably positioned within two inches of axis Z, is more preferably positioned with in one inch of axis Z, and is most preferably positioned directly above pin 38 and generally centered on axis Z. The individual's right hip ball-and-socket joint is similarly positioned with respect to the comparable pivot point associated with upper leg support 95 and lower leg support 97. Such construction of chair 80 is important because when upper 94 and lower 96 leg supports pivot between the stowed position and the deployed position, the individual's leg pivots about its associated hip joint. Correlating the axis Y (FIG. 12) of upper 94 and lower 96 supports such that it passes through the axis of rotation Z (FIG. 12) maintains proper alignment of the individual's leg with upper 94 and lower 96 supports and minimizes any stress produced on the individual's leg during movement of the upper leg support 94 and lower leg support 96 between the stowed and deployed positions.

Deployable stirrup assembly 51 is described in more detail with reference to FIGS. 14 to 16. Stirrup assembly 51 is constructed such that it has a stowed position in which the assembly 51 fits inside armrest 92 in the manner illustrated in FIG. 11 when cover 81 is closed; and, has a deployed position in which member 53 extends through U-shaped aperture 101 and is canted inwardly away from wall 87 of armrest 92 and toward opposing armrest 93 in the manner illustrated in FIGS. 12 and 13.

Stirrup assembly 51 includes hollow tubular member 56. The left hand end of member 56 is fixedly secured to side 88. This end of member 56 can, if desired, be pivotally secured to side 88 with a pin 106 shown in ghost outline in FIG. 14 or with a universal joint which permits member 56 to pivot in any desired direction. Telescoping member 54 is slidably, rotatably received by member 56. Member 53 is pivotally secured to member 54 by pin 55. When member 54 rotates about the longitudinal axis of members 54 and 56, member 53 and stirrup 52 simultaneously rotate with member 54. When stirrup assembly 51 is in the deployed position illustrated in FIGS. 12, 13, 14, member 54 has been rotated in the direction of arrow K about the longitudinal axis of members 54 and 56 such that member 53 rotates simultaneously with member 54 and is canted to extend through and outwardly away from U-shaped opening 101.

FIG. 15 is a bottom view of stirrup assembly 51 after it is moved from the deployed position of FIG. 14 to a stowed position completely inside armrest 92. Moving stirrup assembly 51 from the deployed to the stowed position is accomplished by manually grasping member 53 and first rotating member 54 (and member 53) in the direction of arrow N about the longitudinal axis of members 54 and 56. Member 54 rotates in fixed member 56. This aligns members 53, 54, 56 in a common vertical plane in the manner illustrated in FIG. 15. The direction of rotation indicated by arrow N is opposite the direction of rotation indicated by arrow K. Member 54 is then manually slid into member 56 to the position illustrated in FIG. 15. The reverse procedure is used to deploy stirrup assembly 51.

When assembly 51 is in the deployed position, the sides 52A and 52B of stirrup 52 are generally parallel to axis X which extends through the left hip ball joint 108 of an individual seated in chair 80. This aligns stirrup 52 with the ball joint 108, which makes the chair 80 more comfortable for the individual when the individual is sitting in the chair and the individual's left leg is bent upwardly with his left foot in stirrup 52 and his left knee bent at an elevation above stirrup 52.

The construction and operation of stirrup assembly 41 are comparable to those of stirrup assembly 51, except that, as would be appreciated by those of skill in the art, when assembly 41 is deployed member 43 (FIG. 13) cants inwardly toward armrest 92. Assembly 41 includes stirrup 42.

An alternate stirrup assembly 31 is illustrated in FIG. 17 and includes cylindrical rod 34 with ends rotatably mounted in bushing assemblies 35 and 36 attached to sides 85 and 87, respectively, of armrest 92. The proximate end of arm 33 is fixedly attached to rod 34. Stirrup 32 is fixedly pivotally attached to the distal end of arm 33. The angle T between the center line V of arm 33 and the center line U of rod 34 is approximately fifteen degrees. The angle S between a line perpendicular to the side 87 and the centerline U of rod 34 is approximately twenty degrees. Angles S and T can vary as desired as long as when stirrup assembly 31 is in the stowed position it fits into armrest 92, and when stirrup assembly 31 is in the deployed position the distal end of arm 33 extends outwardly through opening 101 in the canted orientation illustrated in FIGS. 12 ad 13.

FIG. 17 illustrates the stirrup assembly 31 in the stowed position. Assembly 31 is moved from the stowed to the deployed position by manually grasping arm 33 and pivoting simultaneously arm 33 and rod 34 in the manner indicated by arrows Q and R, respectively. Assembly 31 is moved from the deployed to the stowed position by pivoting simultaneously arm 33 and rod 34 in directions opposite those indicated by arrows Q and R, respectively.

Stirrup assemblies 31, 41, 51 can be deployed when chair 80 is in the configuration illustrated in FIG. 10 or is in the configurations illustrated in FIGS. 12 and 13.

While stirrup assemblies 31, 41, 51 are presently manually operated, these assemblies can, if desired, be provided with motor driven mechanical operating systems.

FIG. 10 illustrates the framework of chair 80. The framework of chair 80 is constructed be upholstered with a covering of padding and fabric or leather or other covering material 100 so that chair 80 does not look like a medical device but instead has the general appearance of a La-Z-Boy or other selected reclining upholstered armchair that is typically found in residences throughout the United States. Padding, stuffing, and/or springs are ordinarily utilized in combination with the covering. Disguising the function of the chair 80 in this manner makes a user relax because the atmosphere created by the chair feels more like a familiar area in which the user typically relaxes, i.e., feels more like home. When an ordinary consumer initially views the completed disguised upholstered chair 80, the last thing he suspects is that it includes a pair of concealed, deployable stirrup assemblies. La-Z-Boy recliners or like armchairs do not include deployable stirrup assemblies.

Use of the upper leg portions 94, 95 and their associated lower leg portions 96 and 97 is comparable to use of similar portions found in the chair of FIG. 1, except that the seat 83 in chair 80 is sized comparably with a seat found in a conventional chair. In contrast, the seat in the chair of FIG. 1 is a “short seat” with about half the depth of the seat in a conventional chair.

When stirrup assemblies 31, 41, 51 are deployed, the user sits in the chair with his buttocks on seat 83, tilts back 84 to a substantially horizontally oriented support position, bends his legs upwardly, and places his left foot and right foot in stirrups 52 and 42, respectively. When the user's feet are in stirrups 52 and 42, the back 84 can, if desired, be in a position that is canted or is vertically oriented, but it ordinarily is more comfortable for the back 84 to be in a horizontally oriented configuration with the user's back resting against back 84.

An alternate embodiment 110 of the chair of the invention is illustrated in FIGS. 18 and 20. Chair 110 facilitates an individual's moving from a seated position to an upright position to travel to another piece of furniture to sit or lie, and minimizes the stress on the individual's back and legs. Chair 110 comprises a seat at a first elevation above a floor 40. The seat includes horizontally oriented portion 113 and a back rest 111 attached to the rear of portion 113. The chair also includes a front leg support portion attached to the front of seat portion 113.

The front leg support portion includes a first orthogonal calf rest 116 attached to and spaced downwardly from the front of seat portion 113 and forwardly away from the rear of seat portion 113. The first calf rest 116 has an upper surface 116A (visible in FIG. 18) and a lower surface 1166 (not visible in FIG. 18). The lower surface is parallel to and spaced apart from upper surface 116A.

The front leg support portion also includes a second orthogonal calf rest 117 attached to and spaced downwardly from the front of seat portion 113 and forwardly away from the rear of seat portion 113. The second calf rest 117 is generally adjacent the first calf rest and includes an upper surface 117A (visible in FIGS. 18 and 20) and a lower surface (not visible in FIGS. 18 and 20). The lower surface is parallel to and spaced apart from the upper surface 117A.

A foot rest 119 (FIG. 20) is connected to and extends outwardly from the lower surface 116B of calf rest 116. A similar foot rest (not visible) is connected to and extends outwardly from the lower surface of calf rest 117.

In FIG. 27, the upper end of elongate arm 159 is pivotally attached to shaft 165 by universal joint 166. Joint 166 permits arm 159 to pivot about joint 166 in any of the directions indicated by arrows C2, C3, C4, and C5. In addition, joint 166 permits arm 159 to rotate about the longitudinal axis of arm 159 in the manner indicated by arrows C1.

Elongate shaft 118A is mounted on the front of seat portion 113. The upper end of arm 118 is pivotally attached to one end of shaft 118A. Arm 118 is also fixedly pivotally secured to the outer edge of calf rest 116 in the manner illustrated in FIG. 18. The upper end of another “secondary” arm (not visible) equivalent in shape, dimension, and function to arm 118 is fixedly pivotally secured to the other end of shaft 118A.

Arm 118 (and the “secondary” arm) preferably is generally equivalent to arm 159 (FIG. 27); shaft 118A preferably is generally equivalent to shaft 165; and, the upper end of arm 118 preferably is attached to shaft 118A by a joint comparable to joint 166. This means that arm 118 (and the “secondary” arm), and therefore calf rest 116 (and calf rest 117), can be pivoted in the manner indicated by arrows C1 to C5 in FIG. 27.

The first 116 and second 117 calf rests are each pivotally movable between at least two operative positions, a primary upwardly facing orientation and a secondary laterally facing orientation, each of said first and section foot rests moving away from the other when moving from the primary orientation to said secondary orientation. In FIG. 18, each calf rest 116 and 117 is in the primary upwardly facing orientation. In FIG. 20, calf rest 116 has been pivotally moved from the primary orientation to a secondary orientation, and calf rest 117 is still in its primary orientation. In order to move from the primary to the secondary orientation, calf rest 116 (and therefore arm 118) was pivoted about the longitudinal axis of arm 118 in the manner indicated by arrow C1 in FIG. 27 and arrow A1 in FIG. 20, and, calf rest 116 (and therefore arm 118) was pivoted outwardly in the direction indicated by arrow A2 in FIG. 20 and arrow C4 in FIG. 27.

Cushion 112 is illustrated in ghost outline in an inflated configuration in FIG. 18 and a deflated configuration in FIG. 20. Cushion 112 can be removably or fixedly secured to backrest 111 and/or seat portion 113 when in either or both of its deflated and inflated configurations.

Seat portion 113 is mounted on a support base including upstanding neck 114 upwardly depending from a floor-contacting circular foot 115.

An alternate embodiment 120 of the chair of the invention is illustrated in FIGS. 19 and 21. Chair 120 facilitates an individual's moving from a seated position to an upright position to travel to another piece of furniture to sit or lie, and minimizes the stress on the individual's back and legs.

Chair 120 comprises a seat at a first elevation above a floor 40. The seat comprises a rear seat portion 122 in a generally horizontal orientation, a front seat portion, and a backrest 121 connected to the rear seat portion 122. The front seat portion includes a first section 123 and a second section 124 adjacent the first section. The first and second sections are each movable between at least two operative positions, a first generally horizontal orientation occupying a space extending forwardly from the rear portion 122, and a second generally vertical orientation in which the first and second sections each vacate at least a portion of the space. In FIG. 19, the first 123 and second 125 sections are in the first generally horizontal orientation. In FIG. 21, section 123 is depicted in a second generally vertical orientation in which it has vacated a portion of the space 120A extending forwardly from the rear portion 122.

Section 123 is pivotally mounted on shaft 130. Shaft 130 is fixedly connected to rear seat portion 122. Section 123 is rotatable about the longitudinal axis of shaft 130 such that section 123 is readily moved from the first horizontal orientation of FIG. 19 to the second vertical orientation of FIG. 21 by pivoting section 123 about the horizontally oriented longitudinal axis of shaft 130. The structure and functioning of section 135 and shaft 129 are comparable to that just described for section 123 and shaft 130, except that horizontally oriented shaft 129 is fixedly secured to a side of portion 122 which is opposite and parallel to the side of portion 122 to which shaft 130 is attached so that when section 125 moves from a first horizontal orientation to a second vertical orientation, section 125 pivots upwardly about shaft 129 and pivots away from section 123.

Chair 120 also comprises a front leg support portion attached to the front of sections 123 and 125. The front leg support portion includes a first orthogonal calf rest 124 pivotally attached to the front of section 123. The front leg support portion also includes a second orthogonal calf rest 126 attached to the front of section 125. As can be seen in FIG. 21, calf rest 124 is pivotally interconnected with section 123 by hinge 131. Calf rest 126 is similarly attached to the front of section 125 by a second hinge equivalent in structure and function to hinge 131. Hinge 131 and the like hinge interconnecting calf rest 126 and section 125 permit calf rests 124 and 126 to be pivoted, in the manner indicated by arrow B2 in FIG. 21, downwardly (and upwardly) about an axis passing through hinge 131 and the like hinge interconnecting rest 126 and section 125.

As indicated by arrow B1 in FIG. 21, when section 123 pivots from a first horizontal orientation to a second vertical orientation, rest 124 pivots simultaneously with section 123. In an alternate embodiment of the invention, rest 124 is not connected to section 123, but is instead separately connected to shaft 130 or another portion of the chair 120 such that rest 124 can move independently of section 123 and move and be adjusted in any desired direction or manner.

Although not shown in FIGS. 19 and 21, a foot rest comparable to foot rest 119 (FIG. 20) can be connected to and extend outwardly from the lower surface of each calf rest 124, 126. If desired, the shape and dimension and construction of a foot rest 119 can be varied as desired as long as the foot rest 119 will perform the function of supporting a foot and lower leg of an individual seated in chair 110, 120.

The first 124 and second 126 calf rests are each pivotally movable between at least two operative positions, a primary upwardly facing orientation and a secondary laterally facing orientation, each of said first and section foot rests moving away from the other when moving from the primary orientation to said secondary orientation. In FIG. 19, each calf rest 124 and 126 is in the primary upwardly facing orientation. In FIG. 21, calf rest 123 has been moved from the primary orientation to a secondary orientation, and calf rest 126 is, although it has been tilted down a distance in the direction of arrow B2, considered to still be in a primary orientation. In order to move from the primary to the secondary orientation, calf rest 123 (and therefore rest 124) was pivoted about the longitudinal axis of shaft 130 in the direction indicated by arrow B1 in FIG. 21.

Cushion 112 is illustrated in FIGS. 19 and 21 in a deflated configuration.

Seat portion 122 is mounted on a support base including upstanding neck 127 upwardly depending from a floor-contacting circular foot 128.

A further embodiment 140 of the chair of the invention is illustrated in FIGS. 22 and 23. Chair 140 facilitates an individual's moving from a seated position to an upright position to travel to another piece of furniture to sit or lie, and minimizes the stress on the individual's back and legs. Chair 140 comprises a seat at a first elevation above a floor 40. The seat includes horizontally oriented portion 142 and a backrest 141 attached to the rear of portion 142. The chair also includes a front leg support portion attached to the front of seat portion 142.

The front leg support portion includes a first orthogonal calf rest 147 attached to and spaced downwardly from the front of seat portion 142 and forwardly away from the rear of seat portion 142. The first calf rest 147 has an upper surface (visible in FIG. 22) and a lower surface (not visible in FIG. 22). The lower surface is parallel to and spaced apart from the upper surface.

The front leg support portion also includes a second orthogonal calf rest 145 attached to and spaced downwardly from the front of seat portion 142 and forwardly away from the rear of seat portion 142. The second calf rest 145 is generally adjacent the first calf rest and includes an upper surface (visible in FIGS. 22 and 23) and a lower surface (not visible in FIGS. 22 and 23). The lower surface of calf rest 145 is parallel to and spaced apart from the upper surface of calf rest 145.

If desired, a foot rest 119 is connected to and extends outwardly from the lower surface of each calf rest in the manner that each calf rest 117, 118 of the chair 110 of FIGS. 18 and 20 is provided with a foot rest 119.

Elongate shaft 140A is mounted on the front of seat portion 142. The upper end of arm 148 is pivotally attached to one end of shaft 140A. Arm 148 is also fixedly secured to the outer edge of calf rest 147 in the manner illustrated in FIG. 18. The upper end of another “secondary” arm (not visible) equivalent in shape, dimension, and function to arm 148 is pivotally secured to the other end of shaft 140A and in FIG. 22 is parallel to arm 148. The “secondary” arm is fixedly secured to the outer edge of calf rest 145 in the same manner that arm 148 is fixedly secured to the outer edge of calf rest 147.

Arm 148 (and the “secondary” arm attached to calf rest 145) preferably is generally equivalent to arm 159 (FIG. 27); shaft 140A preferably is generally equivalent to shaft 165; and, the upper end of arm 148 (and the upper end of the “secondary” arm attach to calf rest 145) preferably is attached to shaft 140A by a joint comparable to joint 166. This means that arm 148 (and the “secondary” arm attached to calf rest 145), and therefore calf rest 147 (and calf rest 145), can be pivoted in the manner indicated by arrows C1 to C5 in FIG. 27.

The first 145 and second 147 calf rests are each pivotally movable between at least two operative positions, a primary upwardly facing orientation and a secondary laterally facing orientation, each of said first and section foot rests moving away from the other when moving from the primary orientation to said secondary orientation. In FIGS. 22 and 23, each calf rest 145 and 147 is in a primary upwardly facing orientation. Calf rests 145, 147 are each moved from a primary orientation to a secondary orientation in the same manner which is indicated in FIG. 20 by arrow A1 and in FIG. 21 by arrow B1. When calf rest 145 is moved from its primary to its secondary orientation, calf rest 145 and the “secondary” arm attached to calf rest 145 pivot simultaneously about the longitudinal axis of the “secondary” arm. Similarly, when calf rest 147 is moved from its primary orientation illustrated in FIG. 23 to its secondary orientation, calf rest 147 and arm 148 pivot simultaneously about the longitudinal axis of arm 148.

Cushion 112 is illustrated in an inflated configuration in FIG. 18 and a deflated configuration in FIGS. 22 and 23. Cushion 112 can be removably or fixedly secured to backrest 111 and/or seat portion 113 when in either or both of its deflated and inflated configurations.

The front leg support portion includes a removable orthogonal member 146 which is pivotally detachably mounted intermediate calf rests 145 and 147. Portion 146 can be removed in the manner indicated by arrow C1 in FIG. 23. Member 146 can, if desired, pivot upwardly and downwardly about shaft 140A, either simultaneously with calf rest 145 or 147, or, independently of calf rests 145 and 147. In one embodiment of the invention, member 146 is attached to calf rest 147 (or 145) so that it can rotate simultaneously with calf rest 147 (or 145) and arm 148 (or the “secondary” arm attached to calf rest 145).

Seat portion 142 is mounted on a support base including upstanding neck 143 upwardly depending from a floor-contacting circular foot 144.

Still another embodiment 150 of the chair of the invention is illustrated in FIGS. 24 and 25. Chair 150 facilitates an individual's moving from a seated position to an upright position to travel to another piece of furniture to sit or lie, and minimizes the stress on the individual's back and legs. Chair 150 comprises a seat at a first elevation above a floor 40. The seat includes horizontally oriented portion 152 and a backrest 151 attached to the rear of portion 152. The seat also include generally orthogonal detachable portion 153. Portion 153 can be removed in the manner indicated by arrow P1 in FIG. 25. Horizontally oriented shelf 162 is fixedly secured to the bottom of portion 152 and functions to provide support for portion 153 when portion 153 is mounted in portion 142 in the manner illustrated in FIG. 24. Portion 153 fits in U-shaped opening 160 in the manner illustrated in FIG. 24. Opening 160 is formed in portion 152. Removing portion 153 facilitates ingress into and egress from chair 150 because an individual can position his feet on floor 40 in a position that is more nearly beneath the individual's torso. Similarly removal of portion 146 facilitates ingress into and egress from chair 140 (FIG. 23); pivoting calf rest 116 in the manner indicated by arrows A1 and A2 in FIG. 20 facilitates ingress into and egress from chair 110; and, pivoting calf rest 124 in the manner indicated by arrow B1 in FIG. 21 facilitates ingress into and egress from chair 120.

The chair 150 also includes a front leg support portion attached to the front of seat portion 142. The front leg support portion includes a first orthogonal calf rest 158 attached to and spaced downwardly from the front of seat portion 152 and forwardly away from the rear of seat portion 152. The first calf rest 158 has an upper surface (visible in FIG. 24) and a lower surface (not visible in FIG. 24). The lower surface is parallel to and spaced apart from the upper surface.

The front leg support portion also includes a second orthogonal calf rest 156 attached to and spaced downwardly from the front of seat portion 152 and forwardly away from the rear of seat portion 152. The second calf rest 156 is generally adjacent the removable orthogonal member 157 and includes an upper surface (visible in FIGS. 24 and 26) and a lower surface (not visible in FIGS. 24 and 26). The lower surface of calf rest 156 is parallel to and spaced apart from the upper surface of calf rest 156.

If desired, a foot rest 119 is connected to and extends outwardly from the lower surface of each calf rest 156, 158 in the manner that each calf rest 117, 118 of the chair 110 of FIGS. 18 and 20 is provided with a foot rest 119.

Elongate shaft portions 163, 164, 165 are mounted on the front of seat portion 152. The upper end of arm 159 is pivotally attached to the outer end of shaft 165 by universal joint 166 in the manner illustrated in FIG. 27. Arm 159 is also fixedly secured to the outer edge of calf rest 158 in the manner illustrated in FIGS. 24, 25. The upper end of another “secondary” arm (not visible) equivalent in shape, dimension, and function to arm 159 is pivotally secured to the outer end of shaft 163. The “secondary” arm is fixedly secured to the outer edge of calf rest 156 in the same manner that arm 159 is fixedly secured to the outer edge of calf rest 158. The upper end of the “secondary” arm preferably, but not necessarily, is secured to the outer end of shaft 163 by a universal joint comparable to joint 166. Consequently, arm 159 (and the “secondary” arm attached to calf rest 156), and therefore calf rest 158 (and calf rest 156), can be pivoted in the manner indicated by arrows C1 to C5 in FIG. 27.

The first 158 and second 156 calf rests are each pivotally movable between at least two operative positions, a primary upwardly facing orientation and a secondary laterally facing orientation, each of said first and section foot rests moving away from the other when moving from the primary orientation to the secondary orientation. In FIGS. 24 and 25, each calf rest 158 and 156 is in the primary upwardly facing orientation. Calf rests 158, 156 are each moved from the primary orientation to the secondary orientation in the same manner which is indicated in FIG. 20 by arrow A1 and in FIG. 21 by arrow B1. When calf rest 156 is moved from its primary to its secondary orientation, calf rest 158 and the “secondary” arm attached to calf rest 156 pivot simultaneously about the longitudinal axis of the “secondary” arm. Similarly, when calf rest 158 is moved from its primary orientation illustrated in FIGS. 24 and 25 to its secondary orientation, calf rest 158 and the arm 159 pivot simultaneously about the longitudinal axis of arm 159.

Cushion 112 is illustrated in an inflated configuration in FIG. 18 and a deflated configuration in FIGS. 24 and 35. Cushion 112 can be removably or fixedly secured to backrest 151 and/or seat portion 152 when in either or both of its deflated and inflated configurations.

The front leg support portion of chair 150 includes a removable orthogonal member 157 which is attached to elongate shaft 164 and is mounted intermediate calf rests 156 and 158. Member 157 can be removed in the manner indicated by arrow P2 in FIG. 25. Member 157 can, if desired, pivot upwardly and downwardly about the longitudinal axis of shaft 164, either simultaneously with calf rest 156 or 159, or, independently of calf rests 156 and 150. In one embodiment of the invention, member 157 is removably attached to calf rest 158 (or 156) so that it can rotate simultaneously with calf rest 158 (or 156) and arm 159 (or with calf rest 156 and the “secondary” arm attached to calf rest 156).

Seat portion 152 is mounted on a support base including upstanding neck 154 upwardly depending from a floor-contacting circular foot 155.

A possible configuration of shafts 163, 164, 165 used in conjunction with calf rests 156, 158 and with member 157 is illustrated in FIG. 28. Shaft 163 is replaced by shaft 163A which is identical to shaft 163 except for the detent 169 formed therein. Shaft 165 is replaced by shaft 165A which is identical to shaft 165 except for the detent 168 formed therein. Shaft 164 is replaced by shaft 164A which is identical to shaft 164 except for the fingers 166, 167 outwardly extending from the ends of shaft 164A. Fingers 166 and 167 are shaped and dimensioned to rotatably seat in detents 168 and 169, respectively. When fingers 166 and 167 are seated in detents 168 and 169, shaft 164A can be rotated independently of shafts 163A and 165A.

In FIG. 26, orthogonal members 157 and 153 are pivotally attached to and interconnected by shaft 164.

As would be appreciated by those of skill in the art, the construct(s) utilized to mount calf rests 116, 117, 124, 126, 145, 147, 156, 158 on a chair such that each calf rest can pivot or rotate in the desired manner between first and second operative positions can vary as desired. Similarly, the construct(s) utilized to mount seat portions 123, 125, 153 on a chair such that said seat portions can be pivoted, rotated, or removed in a desired manner can vary as desired. Similarly, the constructs utilized to mount portions 146, 157 on a chair such that said portions 146, 157 can be pivoted, rotated, or removed in a desired manner can vary as desired.

As would be appreciated by those of skill in the art features set forth in one embodiment of the invention can, if desired, be incorporated in another embodiment of the invention. By way of example, and not limitation, sections 123 and 125 in FIG. 19 can be incorporated in the seat portion 113 of chair 110 (FIG. 20) or in the seat portion 142 of chair 140. Consequently, a claimed third embodiment of the invention may not be illustrated in a single drawing but may combine features found in two or more drawings in the disclosure, or, found in two or more features found in separate sections of the written disclosure.

Having described my invention in such terms as to enable those of skill in the art to understand and use it, and having described the presently preferred embodiments and best mode thereof, I Claim:

1. A chair to
facilitate moving from a seated position to an upright position to travel to another piece of furniture to sit or lie, and
minimize the stress on the back and legs,
said chair comprising
(a) a seat at a first elevation above a floor, said seat having
(i) a rear portion in a generally horizontal orientation,
(ii) a front seat portion including
at least a first section (123, 125, 153) movable between at least two operative positions, a first generally horizontal orientation occupying a space forwardly from said rear portion, and a second generally vertical orientation in which said first section vacates at least a portion of said space; and,
(b) a front leg support portion including
(i) a first calf rest (116, 126, 147, 158) attached to and spaced downwardly from said front seat portion and forwardly from said rear portion, said first calf rest having an upper and a lower surface,
(ii) a second calf rest (117, 124, 145, 156) attached to and spaced downwardly from said front seat portion and forwardly from said rear portion, said second calf rest having a top and a bottom surface,
said first and second calf rests each pivotally movable between at least two operative positions, a primary upwardly facing orientation and a secondary laterally facing orientation, each of said first and section foot rests moving away from the other when moving from said primary orientation to said secondary orientation.

2. A chair to
facilitate moving from a seated position to an upright position to travel to another piece of furniture to sit or lie, and
minimize the stress on the back and legs,
said chair comprising
(a) a seat at a first elevation above a floor, said seat having
(i) a rear seat portion in a generally horizontal orientation,
(ii) a front seat portion including
a first section, and
a second section adjacent said first section,
said first and second sections each movable between at least two operative positions, a first generally horizontal orientation occupying a space forwardly from said rear portion, and a second generally vertical orientation in which said first and second sections each vacate at least a portion of said space; and,
(b) a front leg support portion including
(i) a first calf rest attached to and spaced downwardly from said front seat portion and forwardly from said rear portion, said first calf rest having an upper and a lower surface,
(ii) a second calf rest attached to and spaced downwardly from said front seat portion and forwardly from said rear portion, said second calf rest having a top and a bottom surface,
said first and second calf rests each pivotally movable between at least two operative positions, a primary upwardly facing orientation and a secondary laterally facing orientation, each of said first and section calf rests moving away from the other when moving from said primary orientation to said secondary orientation.

3. A chair to
facilitate moving from a seated position to an upright position to travel to another piece of furniture to sit or lie, and
minimize the stress on the back and legs,
said chair comprising
(a) a seat at a first elevation above a floor, said seat having
(i) a rear seat portion in a generally horizontal orientation,
(ii) a front seat portion including
a first section, and
a second section adjacent said first section,
said first and second sections each movable between at least two operative positions, a first generally horizontal orientation occupying a space forwardly from said rear portion, and a second generally vertical orientation in which said first and second sections each vacate at least a portion of said space; and,
(b) a front leg support portion including
(i) a first calf rest attached to and spaced downwardly from said front seat portion and forwardly from said rear portion, said first calf rest having an upper and a lower surface,
(ii) a second calf rest attached to and spaced downwardly from said front seat portion and forwardly from said rear portion, said second calf rest having a top and a bottom surface,
(iii) a first foot rest (119) extending outwardly from said lower surface of said first calf rest, and
(iv) a second foot rest extending outwardly from said bottom surface of said second calf rest,
said first and second calf rests each pivotally movable between at least two operative positions, a primary upwardly facing orientation and a secondary laterally facing orientation, each of said first and second calf rests moving away from the other when moving from said primary orientation to said secondary orientation,
said first foot rest extending laterally toward said second calf rest when said first and second calf rests are each in said secondary laterally facing orientation, and said second foot rest extending laterally toward said first calf rest when said first and second calf rests are each in said secondary laterally facing orientation; and,
(c) an inflatable back support (112) contacting said chair.
